(19) United States
(12) Patent Application Publication
(10) Pub. No.: US 2017/0173965 A1
(43) Pub. Date: Jun. 22, 2017

(54) LIQUID EJECTING APPARATUS

(71) Applicant: SEIKO EPSON CORPORATION, Tokyo (JP)

(72) Inventors: Daisuke HIRUMA, Matsumoto-shi (JP); Eri MARUMOTO, Matsumoto-shi (JP)

(21) Appl. No.: 15/379,897

(22) Filed: Dec. 15, 2016

(30) Foreign Application Priority Data
Dec. 22, 2015 (JP) 2015-249398

(51) Int. Cl. B41J 2/175

(52) U.S. Cl. CPC B41J 2/175

(57) ABSTRACT

A liquid ejecting apparatus includes an ejection unit configured to move in a scanning direction and eject a liquid, a liquid supply unit that is connected to the ejection unit so as to move following the movement of the ejection unit and supplies the liquid from a liquid receptacle to the ejection unit, and a liquid reception unit configured to cover a lower side of a movement region of the liquid supply unit. Configuring the liquid ejecting apparatus in the manner as described above makes it possible to suppress the occurrence of a trouble caused by leakage of the liquid from the liquid supply unit that moves following the movement of the ejection unit.

### BACKGROUND

1. Technical Field

The present invention relates to liquid ejecting apparatuses.

2. Related Art

A variety of liquid ejecting apparatuses have been used. Among those liquid ejecting apparatuses, a large number of liquid ejecting apparatuses including an ejection unit configured to move in a scanning direction and eject a liquid and a liquid supply unit formed of a tube or the like and configured to move following the movement of the ejection unit, are widely used.

For example, JP-A-2004-188629 discloses a liquid ejecting apparatus including an ink reception unit for receiving waste ink and an ink reception unit for covering a region under a reciprocating movement range of an ejection unit (carriage).

### SUMMARY

As a result of concentrated research conducted by the inventors of the invention, it has been found that, in a liquid ejecting apparatus including a liquid supply unit configured to move following the movement of an ejection unit, the liquid supply unit is deteriorated due to the repeated movement of the ejection unit, thereby raising a risk in which a liquid flowing in the liquid supply unit leaks toward a lower side of the liquid supply unit.

However, in the existing liquid ejecting apparatuses, such as the liquid ejecting apparatus disclosed in JP-A-2004-188629 and the like, which include a liquid supply unit configured to move following the movement of an ejection unit, a liquid reception unit for receiving a liquid leaking toward a lower side of the liquid supply unit is not provided (a liquid reception unit is not provided under a movement region of the liquid supply unit) because the above-mentioned risk is not taken into consideration. Accordingly, there is a risk that a trouble such as the interior of the apparatus getting dirty or the like occurs in the case where the liquid leaks toward the lower side of the liquid supply unit.

An advantage of some aspects of the invention is to suppress the occurrence of a trouble caused by the leakage of a liquid from a liquid supply unit configured to move following the movement of an ejection unit.

In order to solve the above issue, a liquid ejecting apparatus according to a first aspect of the invention includes an ejection unit configured to move in a scanning direction and eject a liquid, a liquid supply unit that is connected to the ejection unit so as to move following the movement of the ejection unit and supplies the liquid from a liquid receptacle to the ejection unit, and a liquid reception unit configured to cover a lower side of a movement region of the liquid supply unit.

According to this aspect, there is provided the liquid reception unit configured to cover the lower side of the movement region of the liquid supply unit. Because of this, even if the liquid leaks from the liquid supply unit configured to move following the movement of the ejection unit, the liquid reception unit configured to cover the lower side of the movement region of the liquid supply unit can receive the leaking liquid. This makes it possible to suppress the occurrence of a trouble caused by the leakage of the liquid from the liquid supply unit configured to move following the ejection unit.

A liquid ejecting apparatus according to a second aspect of the invention is a liquid ejecting apparatus in which a hole through which a component can be passed is provided in the liquid reception unit in the first aspect, and the above hole is provided at a position higher than a lower end portion of the liquid reception unit by a predetermined height.

According to this aspect, the liquid reception unit is provided with the hole through which a component can be passed, and the stated hole is provided at a position higher than the lower end portion of the liquid reception unit by a predetermined height. As such, setting the above predetermined height to an appropriate height makes it possible to pass the component through the liquid reception unit and suppress the leakage of the liquid from the liquid reception unit.

Here, “predetermined height” is a height defined based on an amount of liquid or the like stored in the liquid receptacle, that is, a level of height that will not be reached by the liquid received in the liquid reception unit even if an amount of leakage of the liquid is equivalent to the amount of liquid stored in a single liquid receptacle, can be cited as the predetermined height, for example.

The “lower end portion of the liquid reception unit” is a portion that is positioned substantially at the lowermost level of the liquid reception unit, and the stated portion is also referred to as the lower end portion of the liquid reception unit in the case where the stated portion forms a bottom surface such as a horizontal plane or the like.

A liquid ejecting apparatus according to a third aspect of the invention is a liquid ejecting apparatus in which an amount of liquid that can be received in the liquid reception unit is at least equal to or greater than an amount of liquid that can be stored in the single liquid receptacle in the first or second aspect.

According to this aspect, the amount of liquid that can be received in the liquid reception unit is at least equal to or greater than the amount of liquid that can be stored in the single liquid receptacle, thereby making it possible to effectively suppress the leakage of the liquid from the liquid reception unit.

A liquid ejecting apparatus according to a fourth aspect of the invention is a liquid ejecting apparatus in which the liquid reception unit has a lower end portion and a slope portion sloping toward the lower end portion in any one of the first through third aspects.

According to this aspect, the liquid reception unit has the lower end portion and the slope portion sloping toward the lower end portion. This makes it possible to efficiently collect the liquid to the lower end portion using the slope portion and easily remove the liquid that has leaked into the liquid reception unit.

A liquid ejecting apparatus according to a fifth aspect of the invention is a liquid ejecting apparatus in which there are provided a discharge port through which the liquid having been received in the liquid reception unit can be discharged to the exterior of the liquid ejecting apparatus and a stopper that is attachable/detachable to/from the discharge port in any one of the first through fourth aspects.

According to this aspect, there are provided the discharge port through which the liquid having been received in the liquid reception unit can be discharged to the exterior of the liquid ejecting apparatus and the stopper that is attachable/detachable to/from the discharge port. This makes it possible to remove the liquid having leaked into the liquid reception unit particularly with ease.

A liquid ejecting apparatus according to a sixth aspect of the invention is a liquid ejecting apparatus in which a detector configured to detect the leakage of the liquid into the liquid reception unit is provided in any one of the first through fifth aspects.

According to this aspect, the detector configured to detect the leakage of the liquid into the liquid reception unit is provided. This makes it possible to detect the leakage of the liquid from the liquid supply unit and effectively suppress the occurrence of a trouble caused by the leakage of the liquid from the liquid supply unit.

### BRIEF DESCRIPTION OF THE DRAWINGS

The invention will be described with reference to the accompanying drawings, wherein like numbers reference like elements.

FIG. 1 is a schematic perspective view of a printing apparatus according to an embodiment of the invention.

FIG. 2 is a schematic perspective view of a printing apparatus according to an embodiment of the invention.

FIG. 3 is a schematic front view of a printing apparatus according to an embodiment of the invention.

FIG. 4 is a schematic side view of a printing apparatus according to an embodiment of the invention.

FIG. 5 is a schematic perspective view illustrating an inner structure of a printing apparatus according to an embodiment of the invention.

FIG. 6 is a schematic plan view illustrating an inner structure of a printing apparatus according to an embodiment of the invention.

FIG. 7 is a schematic rear view illustrating an inner structure of a printing apparatus according to an embodiment of the invention.

FIG. 8 is a schematic side view illustrating an inner structure of a printing apparatus according to an embodiment of the invention.

FIG. 9 is a block diagram of a printing apparatus according to an embodiment of the invention.

FIG. 10 is a schematic perspective view illustrating a main section of a printing apparatus according to an embodiment of the invention.

FIG. 11 is a schematic perspective view illustrating a main section of a printing apparatus according to an embodiment of the invention.

FIG. 12 is a schematic perspective view illustrating a main section of a printing apparatus according to an embodiment of the invention.

FIG. 13 is a schematic perspective view illustrating a main section of a printing apparatus according to an embodiment of the invention.

FIG. 14 is a schematic plan view illustrating a main section of a printing apparatus according to an embodiment of the invention.

FIGS. 15A and 15B are schematic perspective views each illustrating a main section of a printing apparatus according to an embodiment of the invention.

FIG. 16 is a schematic perspective view illustrating a main section of a printing apparatus according to an embodiment of the invention.

FIG. 17 is a schematic side view illustrating a main section of a printing apparatus according to an embodiment of the invention.

### DESCRIPTION OF EXEMPLARY EMBODIMENTS

Hereinafter, a printing apparatus 1 as a liquid ejecting apparatus according to an embodiment of the invention will be described in detail with reference to the accompanying drawings.

First, an outline of the printing apparatus 1 of the present embodiment will be described.

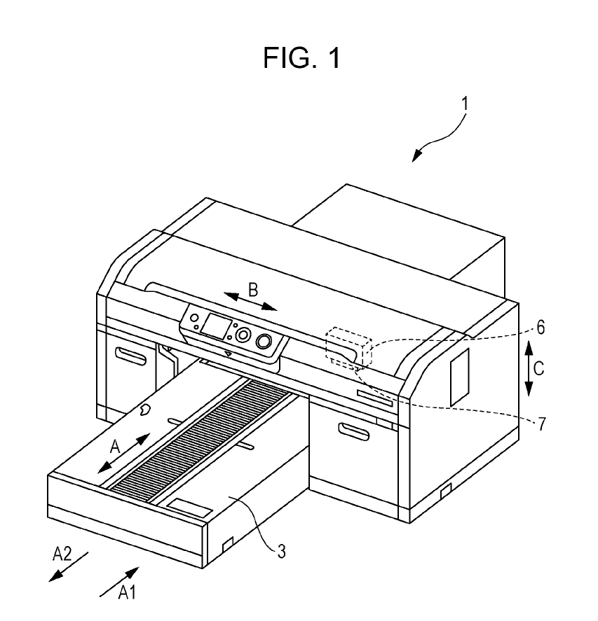

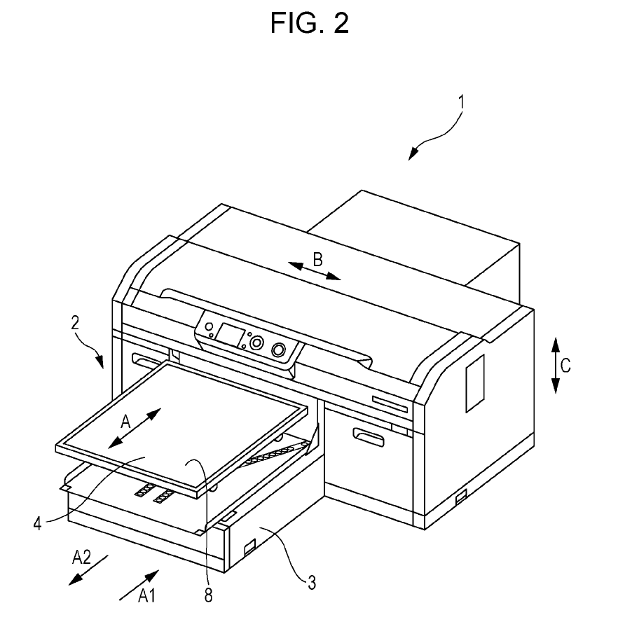

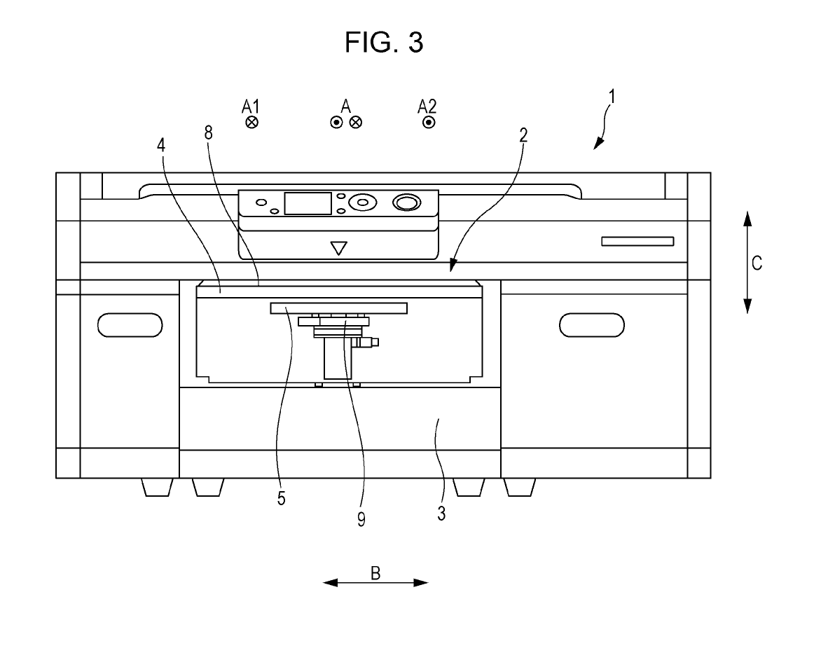

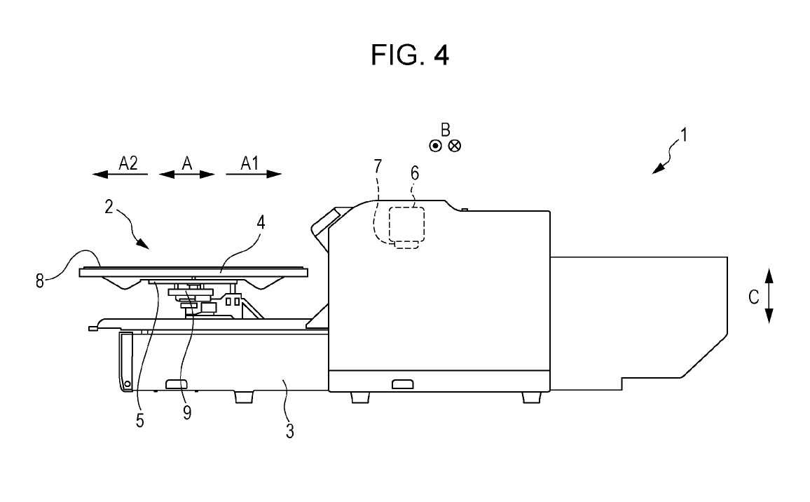

FIGS. 1 and 2 are schematic perspective views of the printing apparatus 1 according to the embodiment. Specifically, FIG. 1 illustrates a state in which a tray 4 serving as a medium supporter in the printing apparatus 1 of the embodiment is placed at a print start position, while FIG. 2 illustrates a state in which the tray 4 is placed at a position for setting a medium. FIG. 3 is a schematic front view of the printing apparatus 1 of the embodiment. FIG. 4 is a schematic side view of the printing apparatus 1 of the embodiment.

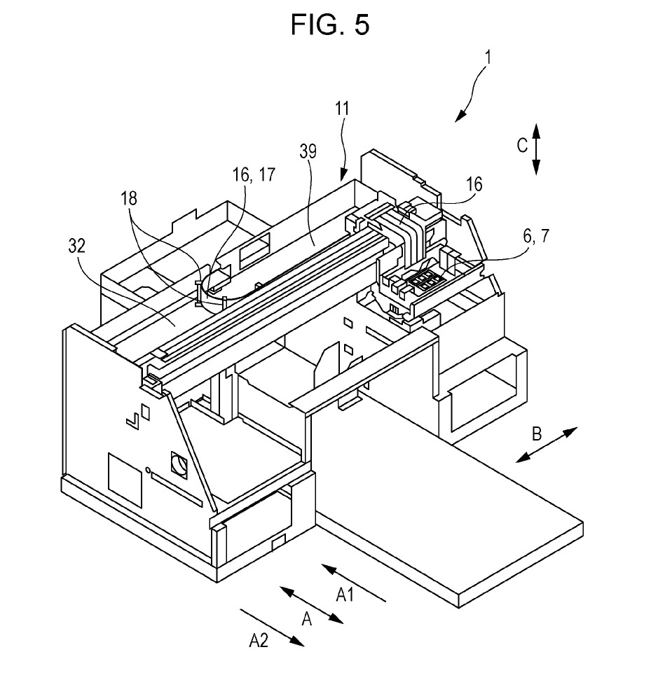

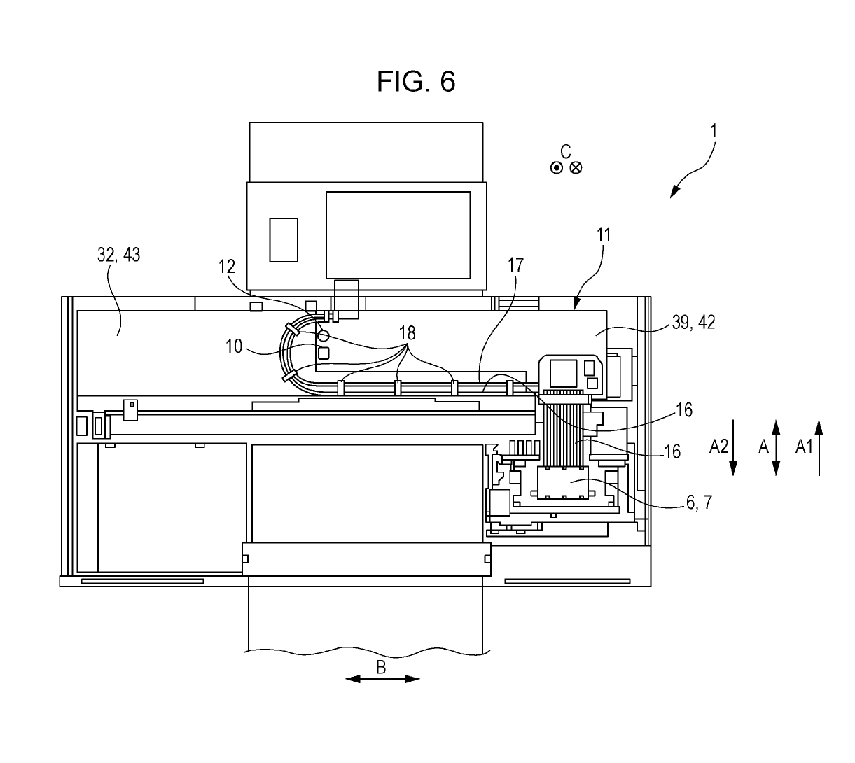

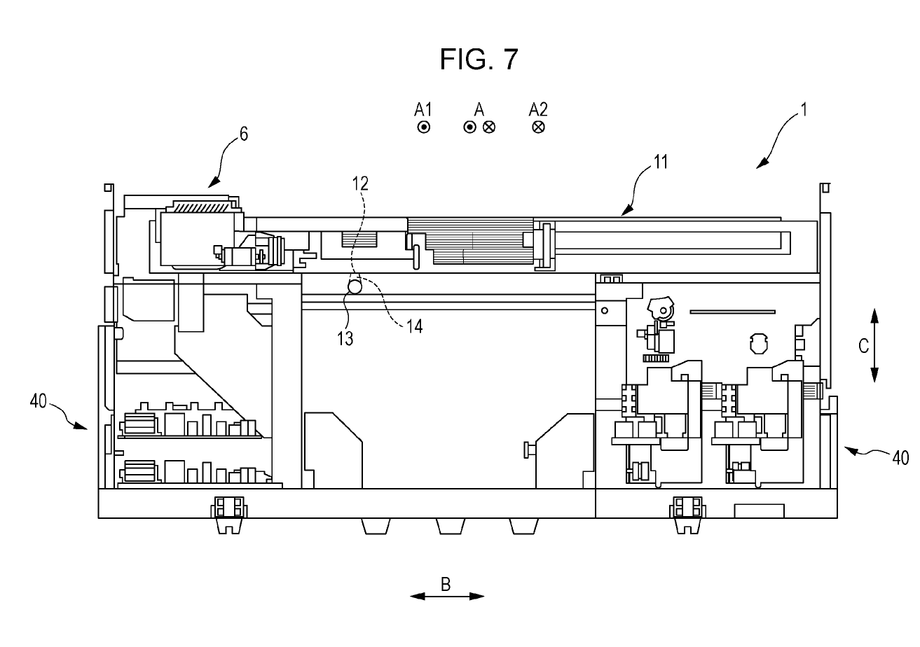

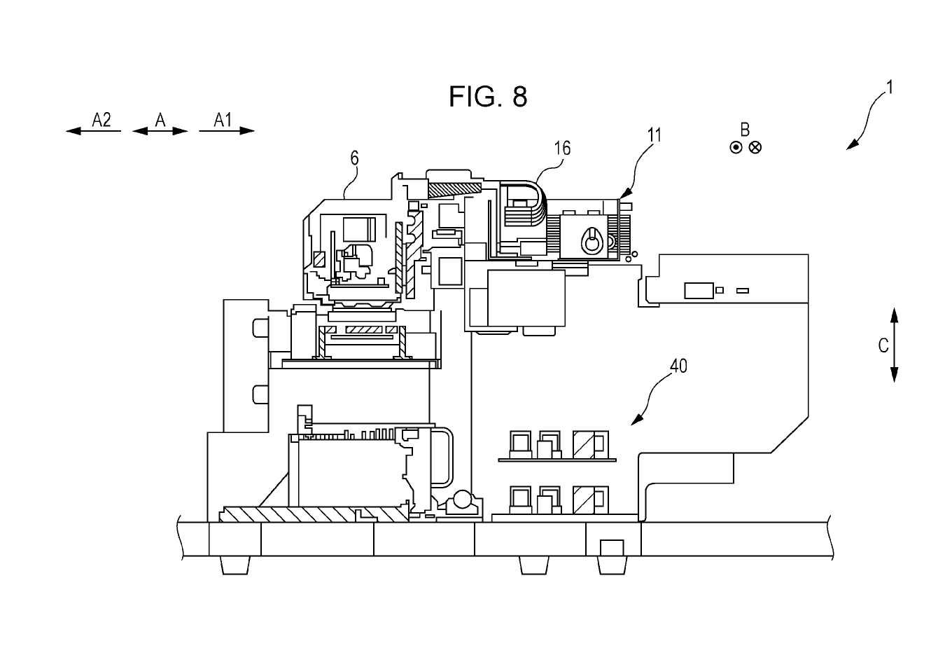

FIGS. 5 through 8 are schematic views each illustrating an inner structure of the printing apparatus 1, and part of constituent members constituting the printing apparatus 1 are not illustrated therein. Specifically, FIG. 5 is a schematic perspective view illustrating the inner structure of the printing apparatus 1, FIG. 6 is a schematic plan view illustrating the inner structure of the printing apparatus 1, FIG. 7 is a schematic rear view illustrating the inner structure of the printing apparatus 1, and FIG. 8 is a schematic side view illustrating the inner structure of the printing apparatus 1.

As shown in FIGS. 2 through 4, the printing apparatus 1 of the embodiment includes a medium support unit 2 configured to move in a movement direction A while supporting a medium on a support surface 8 of the tray 4. The medium support unit 2 includes the tray 4 serving as the medium supporter. The printing apparatus 1 includes a medium transport unit 3 configured to transport a medium supported in the tray 4 in the movement direction A. The movement direction A is a direction including a direction A1 and a direction A2 which is opposite to the direction A1. The tray 4 is placed on a stage 5. Rotating a rotating lever 9 moves the tray 4 along with the stage 5 in a height direction C. As a medium, various types of materials such as a textile (fabric, cloth, or the like), paper, a vinyl chloride resin, and so on can be used.

Further, a printing head 7 capable of printing on a medium by ejecting ink as an example of the liquid is provided inside a main body of the printing apparatus 1. The printing apparatus 1 of the embodiment makes the printing head 7 eject ink therefrom onto a medium that is supported in the tray 4 so as to form a desired image while moving the printing head 7 back and forth in a scanning direction B intersecting with the movement direction A by moving a carriage 6 including the printing head 7 back and forth in the scanning direction B. In the embodiment, the carriage 6 including the printing head 7 is movable in the scanning direction B and corresponds to an ejection unit capable of ejecting ink onto a medium (a printing unit capable of printing an image).

In the printing apparatus 1 of the embodiment, a position on a front side (lower left direction) of FIGS. 1 and 2 is the position for setting a medium in the tray 4 (corresponds to FIG. 2). Then, after the tray 4 in which the medium is set being moved to the print start position on a rear side (upper right direction) of FIGS. 1 and 2 in the direction A1 of the direction A (corresponds to FIG. 1), printing is performed while the tray 4 being moved in the direction A2 of the direction A.

Further, as shown in FIGS. 5 through 8, inside the main body of the printing apparatus 1, there is provided a tube 16 as a liquid supply unit capable of supplying ink to the printing head 7 from an ink cartridge (not shown) as a liquid receptacle. The carriage 6 of the embodiment moves back and forth in the scanning direction B as described before, and the tube 16 is so configured as to move in a tube sliding section 11 while following the reciprocating movement of the carriage 6. The liquid receptacle may be any receptacle as being capable of storing the liquid, and may be a large tank or the like that is disposed outside the main body of the printing apparatus 1.

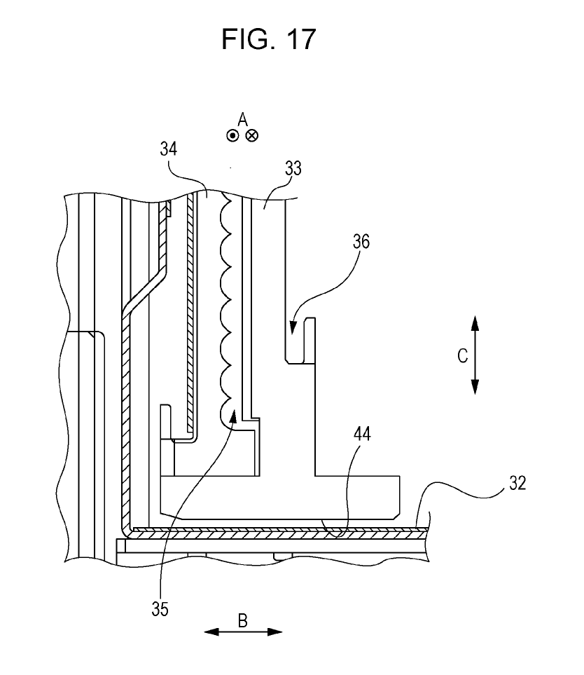

As shown in FIGS. 5 and 6, a slide sheet 32 is pasted on a bottom surface 39 of the tube sliding section 11. With a tube holder 18, which holds the tube 16, sliding on an upper surface of the slide sheet 32, the tube 16 is allowed to move in the tube sliding section 11 following the reciprocating movement of the carriage 6. A lower surface of the tube holder 18 (a contact surface 44 (see FIG. 17) in contact with the slide sheet 32) is so processed as to have a small friction coefficient against the slide sheet 32 in order to obtain excellent sliding capability with respect to the slide sheet 32.

The tube sliding section 11, details of which will be explained later, is so configured as to cover a lower side of a movement region of the tube 16, and is also configured to be capable of receiving ink leaking from the tube 16 in a case of breakage of the tube 16. In the printing apparatus 1 of the embodiment, the tube sliding section 11 serves as a liquid reception unit in the manner as described above, and is so configured as to prevent the ink from making contact with constituent members 40 (see FIGS. 7 and 8) of the printing apparatus 1 positioned on the lower side of the movement region of the tube 16, even if the tube 16 is broken.

In the tube sliding section 11, there is provided a sensor 10 capable of detecting the leakage of ink from the tube 16, and further there is provided a discharge port 12 for discharging ink in the case of the leakage of the ink from the tube 16 (see FIG. 6). A drain tube 14 is formed extending downward from the discharge port 12, and a drain plug 13 as a stopper attachable/detachable to/from the drain tube 14 is provided at a leading end of the drain tube 14. Note that the drain plug 13 may be so configured as to be directly attachable/detachable to/from the discharge port 12 without the drain tube 14 interposed therebetween. In other words, it is sufficient for the stopper to be directly or indirectly attachable/detachable to/from the discharge port 12. The above-discussed configuration makes it possible to easily discharge ink in the case of the leakage of the ink from the tube 16.

Next, an electric configuration of the printing apparatus 1 of the embodiment will be described.

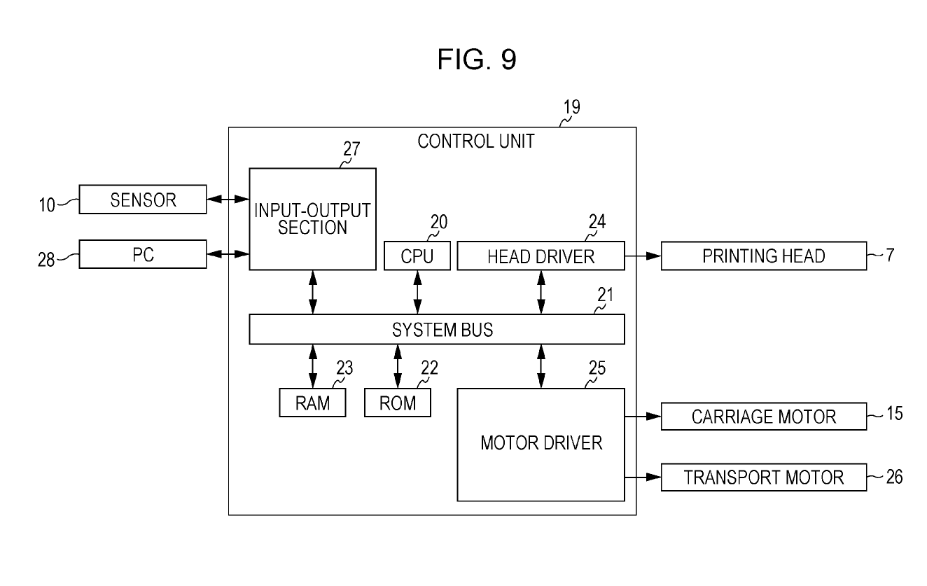

FIG. 9 is a block diagram of the printing apparatus 1 of the embodiment.

In a control unit 19, there is provided a CPU 20 in charge of the overall control of the printing apparatus 1. The CPU 20 is connected, via a system bus 21, to a ROM 22 in which various types of control programs and the like to be executed by the CPU 20 are stored, and to a RAM 23 in which data can be temporarily stored.

The CPU 20 is connected to a head driver 24 for driving the printing head 7 (making the printing head 7 eject ink) via the system bus 21.

Further, the CPU 20 is connected to a motor driver 25 via the system bus 21. The motor driver 25 is connected to a carriage motor 15, and to a transport motor 26 provided in the medium transport unit 3 for transporting the medium (in other words, for moving the medium support unit 2).

Moreover, the CPU 20 is connected to an input-output section 27 via the system bus 21. The input-output section 27 is connected to the sensor 10 capable of detecting the leakage of ink from the tube 16, and to a PC 28 for sending/receiving data, such as print data or the like, and signals.

Next, the tube sliding section 11 which is a main section of the printing apparatus 1 of the embodiment will be described.

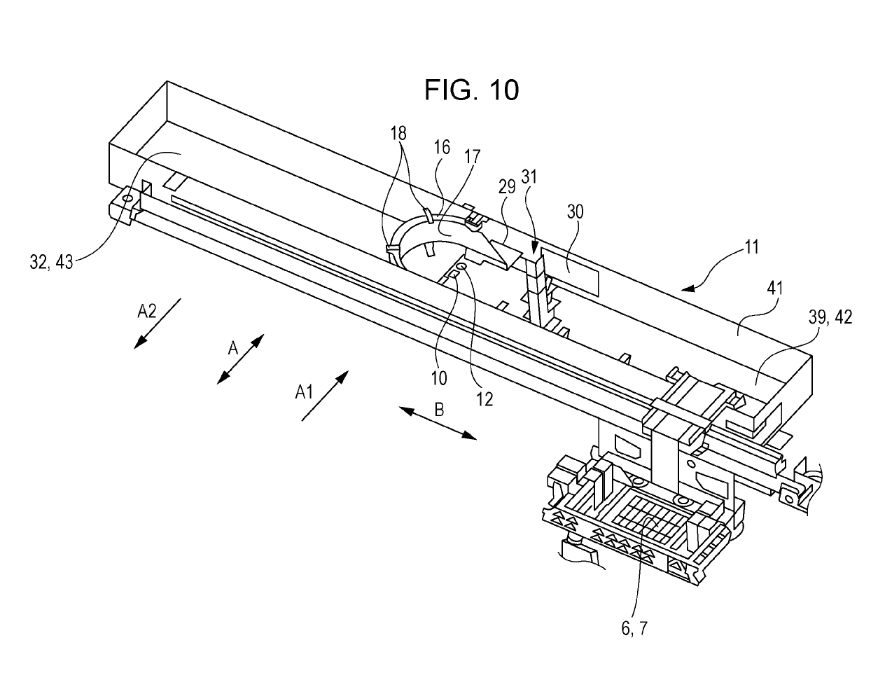

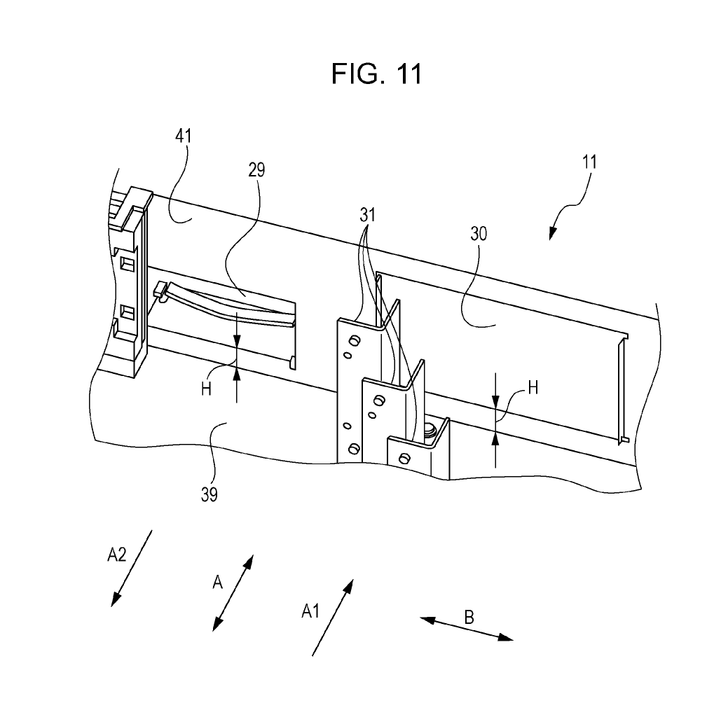

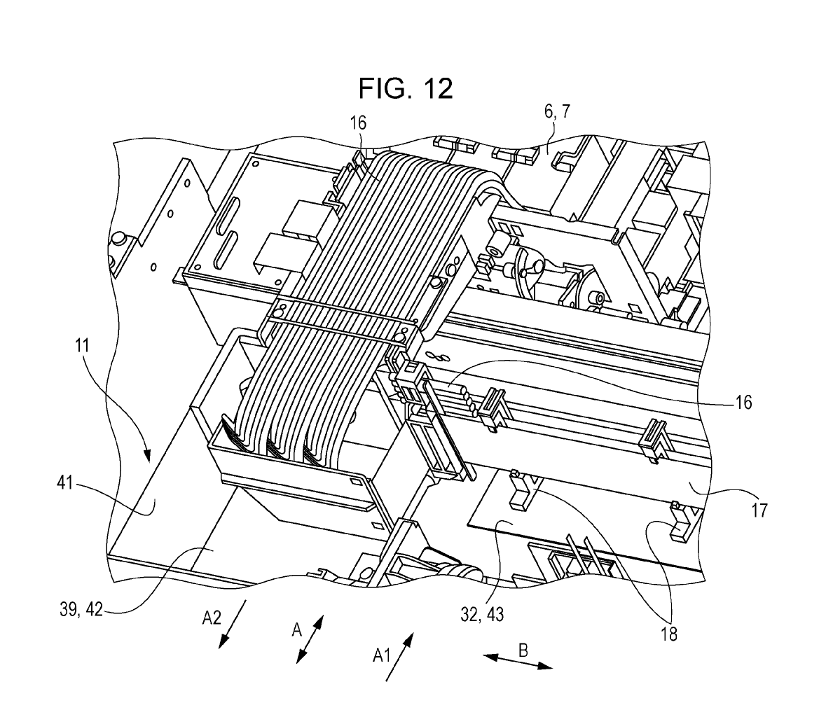

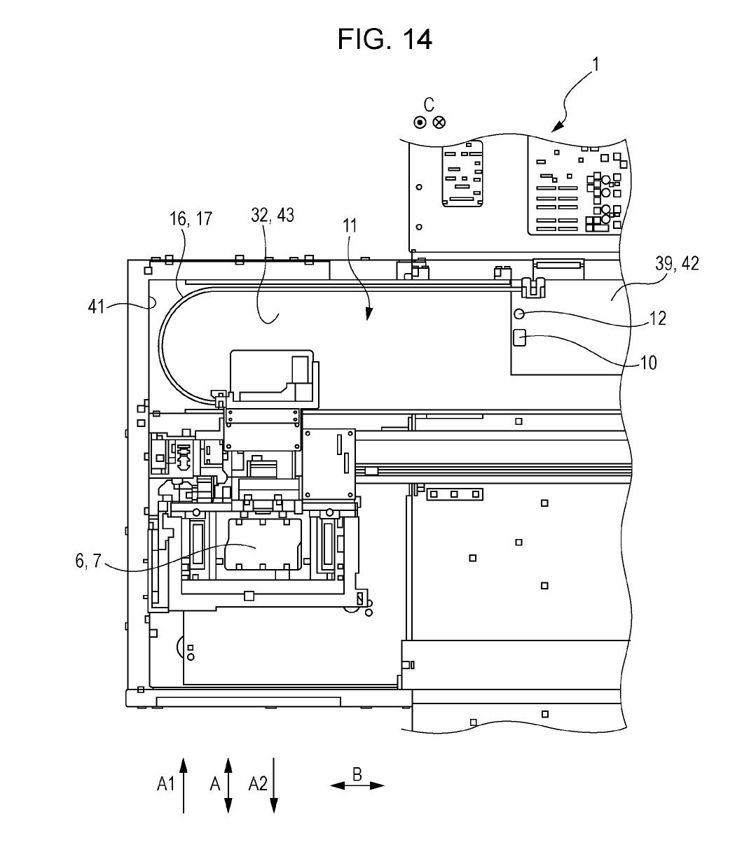

FIG. 10 is a schematic perspective view illustrating the tube sliding section 11 which is the main section of the printing apparatus 1 of the embodiment, FIGS. 11 through 13 are schematic perspective views each illustrating part of the tube sliding section 11, and FIG. 14 is a schematic plan view illustrating part of the tube sliding section 11. Note that in FIGS. 10 through 14, part of the constituent members are omitted so as to make the shapes thereof easily recognized in the explanation of the constituent members.

As shown in FIG. 10, the tube sliding section 11 has a shape in which a side surface 41 is formed on the perimeter of the bottom surface 39 and there are provided holes (holes 29, 30, and so on) in the side surface 41 through which a plurality of components can be passed. However, each of the holes is provided at a position higher than a lower end portion 43 of the tube sliding section 11 (a region of the bottom surface 39 where the slide sheet 32 is pasted) by a predetermined height H (see FIG. 11), thereby making it possible to receive a predetermined amount of ink.

As the holes, as illustrated in FIGS. 10 and 11, for example, there are provided the hole 29 through which a flexible flat cable 17 (hereinafter, referred to as “FFC 17”) can be passed, the hole 30 through which the tube 16 can be passed, and so on.

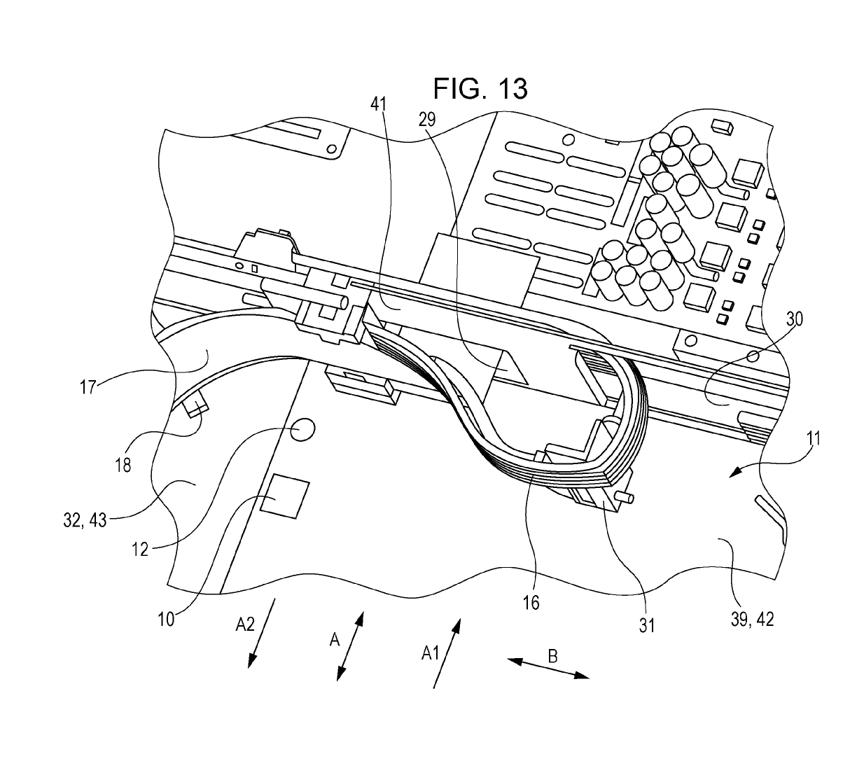

The tube 16 is held by a plurality of tube holders 18 while extending from the printing head 7 toward the hole 30, and is passed to the outside of the hole 30 via a tube fixing portion 31 as illustrated in FIG. 13. Note that in FIG. 13, only one of a plurality (three) of tube fixing portions 31 and only part of a plurality of tubes 16 are illustrated, and a state where the tube 16 is arranged extending from the hole 30 toward the left side in FIG. 13 is illustrated. However, in reality, the tube 16 is also arranged extending from the hole 30, via another tube fixing portion 31, toward the right side in FIG. 13.

In the tube sliding section 11 of the embodiment, since the tube holder 18 holding the tube 16 slides, along with the movement of the tube 16, on a region of the bottom surface 39 where the slide sheet 32 is pasted, the stated region forms a horizontal surface so that the tube holder 18 can smoothly slide thereon. While taking the region where the slide sheet 32 is pasted (horizontal surface) as a lower end (the lower end portion 43), the region other than the lower end in the bottom surface 39 forms a gentle slope (slope portion 42). The sensor 10 and the discharge port 12 are provided in a boundary portion between the horizontal surface and the gentle slope (that is, in a part of the lower end portion 43 of the tube sliding section 11) and are configured so that the leakage of ink from the tube 16 can be efficiently detected and ink can be discharged if the ink leaks from the tube 16. This is because ink is likely to be collected in the boundary portion between the gentle slope and the horizontal surface since the ink flows from the gentle slope toward the horizontal surface. Note that, however, the sensor 10, the discharge port 12, and the like may be provided in an arbitrary position within the lower end portion 43.

To summarize the printing apparatus 1 of the embodiment, the printing apparatus 1 of the embodiment includes the carriage 6 that moves in the scanning direction B and ejects ink, and the tube 16 that is connected to the carriage 6 so as to move following the movement of the carriage 6 and supplies ink to the carriage 6 from an ink cartridge (not shown) as the liquid receptacle.

The printing apparatus 1 further includes the tube sliding section 11 as the liquid reception unit configured to cover the lower side of the movement region of the tube 16. With this, even if ink leaks from the tube 16 that moves following the movement of the carriage 6, the tube sliding section 11 covering the lower side of the movement region of the tube 16 can receive the leaking ink.

As such, the printing apparatus 1 of the embodiment is so configured as to suppress the occurrence of a trouble caused by the leakage of ink from the tube 16 that moves following the movement of the carriage 6.

Further, as discussed above, the tube sliding section 11 of the embodiment includes holes such as the holes 29, 30, and so on capable of passing therethrough the FFC 17 and the tube 16 which are examples of the components; each of these holes is provided at a position higher than the lower end portion 43 of the tube sliding section 11 (region of the bottom surface 39 where the slide sheet 32 is pasted) by the predetermined height H. As such, the printing apparatus 1 of the embodiment is so configured as to be capable of passing the components through the tube sliding section 11 and suppressing the leakage of ink from the tube sliding section 11.

Here, the “predetermined height” is a height defined based on the amount of liquid or the like stored in the liquid receptacle. In the printing apparatus 1 of the embodiment, for example, each of the holes is provided at a level of height that will not be reached by the ink received in the tube sliding section 11 even if all the ink in an amount equivalent to the amount of ink stored in a single ink cartridge of a plurality of mounted ink cartridges has leaked out.

The “lower end portion of the liquid reception unit” (the lower end portion 43 of the tube sliding section 11) refers to a portion that is positioned substantially at the lowermost level of the liquid reception unit, and the stated portion is also referred to as the lower end portion of the liquid reception unit in the case where, like in this embodiment, the stated portion forms the bottom surface 39 such as the horizontal surface or the like.

To rephrase the above description, an amount of ink that can be received in the tube sliding section 11 as the liquid reception unit of the embodiment, can be expressed as being at least equal to or greater than an amount of ink that can be stored in a single cartridge. The leakage of ink from the tube sliding section 11 is effectively suppressed by the printing apparatus 1 of the embodiment being configured in the manner as discussed above.

Further, as discussed before, the tube sliding section 11 of the embodiment includes the lower end portion 43 and the slope portion 42 sloping toward the lower end portion 43. With this, the printing apparatus 1 of the embodiment is so configured as to be capable of efficiently collecting ink in the lower end portion 43 using the slope portion 42 and easily removing the ink leaking into the tube sliding section 11.

The printing apparatus 1 of the embodiment includes the discharge port 12 capable of discharging the ink having been received in the tube sliding section 11 to the exterior of the printing apparatus 1 therethrough as illustrated in FIG. 6 and the like, and the drain plug 13 attachable/detachable to/from the drain tube 14 (in other words, to/from the discharge port 12) connected to the discharge port 12 as illustrated in FIG. 7. With this, ink having leaked into the tube sliding section 11 can be removed particularly with ease by attaching/detaching the drain plug 13.

In the printing apparatus 1 of the embodiment, although the drain plug 13 attachable/detachable to/from the discharge port 12 is provided, ink having leaked into the tube sliding section 11 can be easily removed by forming a cock, in place of the drain plug 13, and opening/closing the cock.

The printing apparatus 1 of the embodiment includes the sensor 10 as the detector configured to detect the leakage of ink into the tube sliding section 11, as shown in FIG. 6 and the like. As such, the printing apparatus 1 is so configured as to be capable of detecting the leakage of ink from the tube 16 and effectively suppressing the occurrence of a trouble caused by the ink leakage from the tube 16.

The tube holder 18 of the printing apparatus 1 of the embodiment will be described next.

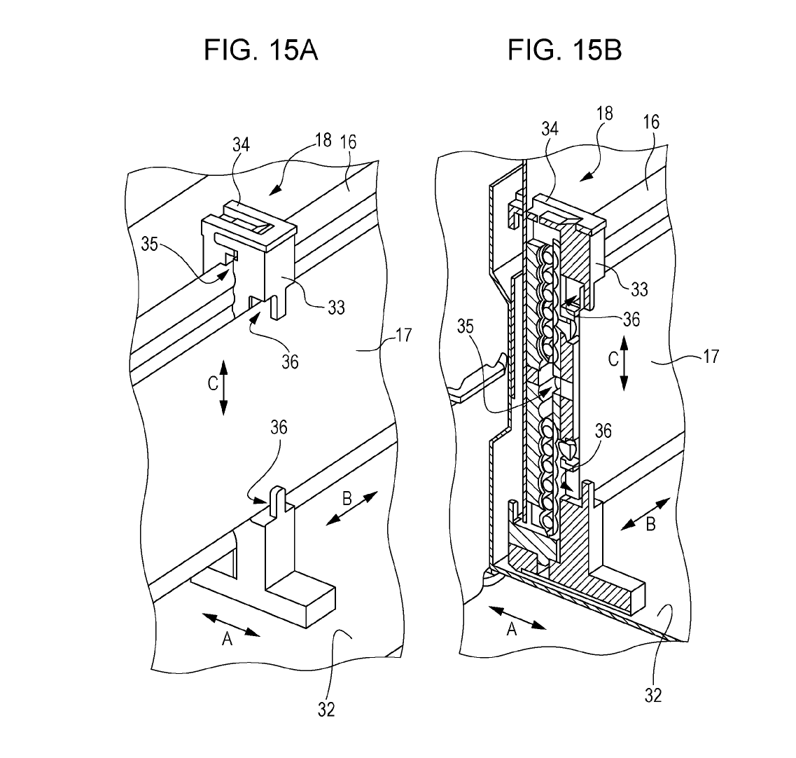

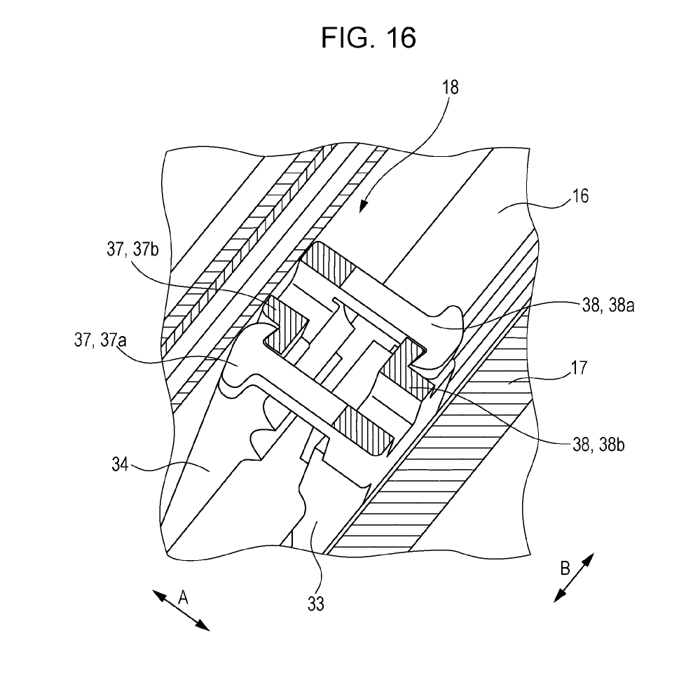

FIGS. 15A through 17 are schematic views of the tube holder 18. Specifically, FIGS. 15A and 15B illustrate a state where the tube holder 18 holds the tube 16; FIG. 15A is a schematic perspective view thereof and FIG. 15B is a schematic cross-sectional view thereof. FIG. 16 illustrates a schematic cross-sectional perspective view indicating a connecting portion between a first member 33 and a second member 34 constituting the tube holder 18. FIG. 17 illustrates a schematic side view of a lower side portion of the tube holder 18 (a portion on the contact surface 44 side in contact with the slide sheet 32).

As shown in FIGS. 15A through 17, the tube holder 18 of the embodiment is constituted of the first member 33 and the second member 34. Further, the tube holder 18 of the embodiment is so configured as to be capable of holding not only the tube 16 but also the FFC 17. To be specific, as shown in FIGS. 15A and 15B, the tube 16 can be held in a gap portion 35 between the first member 33 and the second member 34, while the FFC 17 can be held by grappling the FFC 17 to a grappling portion 36 provided in the first member 33. On a side of the second member 34 where the tube 16 is held, a concavo-convex portion corresponding to each of the plurality of tubes 16 is provided as shown in FIG. 17, thereby suppressing the tubes 16 being shifted.

As shown in FIG. 16, the first member 33 and the second member 34 are connected with connecting portions 37 and 38. Specifically, an engagement portion 37a formed in the first member 33 is engaged with a target engagement portion 37b formed in the second member 34, and an engagement portion 38a formed in the second member 34 is engaged with a target engagement portion 38b formed in the first member 33, thereby the first member 33 and the second member 34 being connected.

Because the tube holder 18 of the embodiment is so configured as to be capable of sliding on the slide sheet 32 as discussed before, the contact surface 44 to be in contact with the slide sheet 32 has been so processed as to have a small friction coefficient against the slide sheet 32. To be specific, a seal with a small friction coefficient against the slide sheet 32 is pasted on the contact surface 44. However, the configuration is not limited thereto, and a process, such as physical or chemical surface treatment on the contact surface 44, may be carried out to make the friction coefficient smaller against the slide sheet 32.

The invention is not limited to the above embodiment, and various modifications can be made within the scope of the invention as defined in the appended aspects of the invention; and it goes without saying that such modifications are also encompassed in the scope of the invention.

This application claims priority under 35 U.S.C. §119 to Japanese Patent Application No. 2015-249398, filed Dec. 22 2015. The entire disclosure of Japanese Patent Application No. 2015-249398 is hereby incorporated herein by reference.

What is claimed is:

1. A liquid ejecting apparatus comprising:
an ejection unit configured to move in a scanning direction and eject a liquid;
a liquid supply unit that is connected to the ejection unit so as to move following movement of the ejection unit and supplies the liquid from a liquid receptacle to the ejection unit; and
a liquid reception unit configured to cover a lower side of a movement region of the liquid supply unit.

2. The liquid ejecting apparatus according to claim 1,
wherein a hole through which a component can be passed is provided in the liquid reception unit, and
the hole is provided at a position higher than a lower end portion of the liquid reception unit by a predetermined height.

3. The liquid ejecting apparatus according to claim 1,
wherein an amount of liquid that can be received in the liquid reception unit is at least equal to or greater than an amount of liquid that can be stored in the single liquid receptacle.

4. The liquid ejecting apparatus according to claim 1,
wherein the liquid reception unit includes a lower end portion and a slope portion sloping toward the lower end portion.

5. The liquid ejecting apparatus according to claim 1, further comprising:
a discharge port through which the liquid having been received in the liquid reception unit can be discharged to the exterior of the liquid ejecting apparatus; and
a stopper that is attachable/detachable to/from the discharge port.

6. The liquid ejecting apparatus according to claim 1, further comprising:
a detector configured to detect leakage of the liquid into the liquid reception unit.
